(19) United States
(12) Patent Application Publication
(10) Pub. No.: US 2017/0353842 A1
(43) Pub. Date: Dec. 7, 2017

(54) SECURE COMMUNICATIONS VIA A MOBILE KEYBOARD APPLICATION OF A MOBILE DEVICE

(71) Applicant: Nuance Communications, Inc., Burlington, MA (US)

(72) Inventor: Gordon Waddell, Burlington, MA (US)

(21) Appl. No.: 15/176,115

(22) Filed: Jun. 7, 2016

(51) Int. Cl. H04W 4/14; H04W 12/02; H04M 1/725

(52) U.S. Cl. CPC H04W 4/14; H04M 1/72519; H04W 12/02

(57) ABSTRACT

Systems and methods are described herein for providing secure communications (e.g., text or other data messages) via a keyboard application of a mobile device. In some cases, the keyboard application acts as an end-to-end obfuscation or other security mechanism for communications between one mobile device and another (e.g., via a message application on each device that utilizes a virtual keyboard for text entry and other user input). For example, the keyboard application may provide, among other things, transient or temporary access to the plain or original text of otherwise secured or unreadable messages, without storing readable content of the messages on the device or within the application.

### BACKGROUND

Mobile electronic devices (such as smart phones, personal digital assistants, computer tablets, smart watches, and so on) are ubiquitous. Mobile devices provide advanced computing capabilities and services to users, such as voice communications, text and other messaging communications, video and other multimedia communications, streaming services, and so on. Often, users, via their mobile devices, access such services as customers or subscribers of telecommunications carriers, which provide telecommunications networks within which the users make voice calls, send text messages, send and receive data, and otherwise communicate with one another.

Given the ubiquity and reliance on mobile devices by users, device manufacturers provide various security systems or mechanisms that facilitate secure, or seemingly secure, communication of information (e.g., voice or data information) between devices. For example, devices may include specific security applications that encrypt or encode (and, decrypt or decode) communications sent to/from the devices. As another example, communication applications (such as hardware, operating system, or application heterogeneous applications) may also provide certain security measures, such as end-to-end encryption or other security protocols within their application-specific contexts or environments.

### BRIEF DESCRIPTION OF THE DRAWINGS

Embodiments of the present technology will be described and explained through the use of the accompanying drawings.

FIG. 1 is a block diagram illustrating a suitable computing environment within which to provide secure communications via virtual keyboards of mobile devices.

FIG. 2 is a block diagram illustrating components of a keyboard obfuscation system.

FIG. 3 is a flow diagram illustrating a method for obfuscating a message via a virtual keyboard of a mobile device.

FIG. 4 is a display diagram illustrating an obfuscated version of a message generated by the keyboard obfuscation system.

FIGS. 5A-5C are display diagrams illustrating various different obfuscated versions of messages.

FIG. 6 is a flow diagram illustrating a method for displaying a message received by a messaging application of a mobile device.

FIG. 7 is a display diagram illustrating the display of a readable version of an obfuscated message generated by the keyboard obfuscation system.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Systems and methods are described herein for providing secure communications (e.g., text or other data communications) via a keyboard application of a mobile device. In some cases, the keyboard application acts as an end-to-end obfuscation or security mechanism for communications between one mobile device and another (e.g., via a messaging application on each device that utilizes a virtual keyboard for text entry and other user input).

For example, the keyboard application may provide, among other things, transient or temporary access to the plain or original text of otherwise secured or unreadable messages, without storing readable content of the messages on the device or within the application.

In some embodiments, the systems and methods may, via a keyboard application of a mobile device, access a selection of text located in a text buffer of the keyboard application, such as text entered by a user of the mobile via a virtual keyboard provided by the keyboard application and launched within a messaging application of the mobile device, generate an obfuscated version of the received selection of text, and provide the obfuscated version of the received selection of text to the messaging application of the mobile device for communication to a recipient.

In some embodiments, the systems and methods may, via the keyboard application, access an obfuscated version of a text message presented by a messaging application of the mobile device, receive, via a virtual keyboard provided by the keyboard application, a request to display a de-obfuscated version of the text message, de-obfuscate the obfuscated version of the text message in response to the request, and display (temporarily or otherwise) a readable version of the text message to the user of the mobile device based on the de-obfuscation of the text message.

In some cases, the systems and methods may display temporary or transient versions of displayed messages, without storing the displayed, readable versions of coded or obfuscated messages received via messaging applications and other communication applications of the mobile device.

Therefore, in some embodiments, the systems and methods enable users to send obfuscated, encrypted, scrambled, or otherwise unreadable messages and other communications via various communication applications of their mobile devices (which may only store the messages in their unreadable format), because the keyboard applications of their mobile devices facilitate the obfuscation (and, de-obfuscation) of their communications in a transient and/or temporary manner (e.g., for a short duration and without storing de-obfuscated contents of the communications).

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

### Examples of Suitable Computing Environments

As described herein, in some embodiments, the systems and methods facilitate and/or manage secure communications between devices (e.g., text messages or other text-based communications) via keyboard applications of the mobile devices. As described herein, the keyboard application may act as an end-to-end obfuscation or other security mechanism for communications between one mobile device and another, by generating coded (e.g., obfuscated, encrypted, scrambled, or otherwise unreadable) messages for senders of messages, and/or by decoding (e.g., de-obfuscating, de-encrypting, de-scrambling, or otherwise translating) messages for recipients of coded messages.

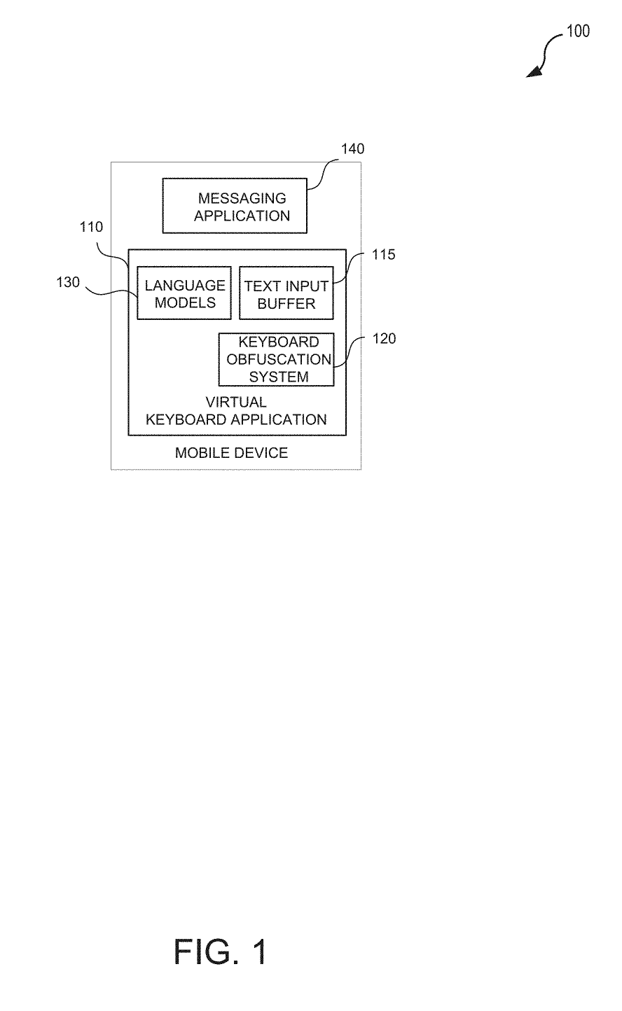

FIG. 1 is a block diagram illustrating a suitable computing environment and/or system to provide secure communications via virtual keyboards of mobile devices. The computing environment or system may include or be supported by a mobile device 100 or other computing device, such as a mobile or smart phone, tablet computer, laptop, mobile media device, mobile gaming device, vehicle-based computer, wearable computing device, and so on), to access various services (e.g., voice, message, and/or data services) supported by a telecommunications network (not shown) that is provided by a telecommunications (wireless) carrier and/or a wireless network (not shown).

The mobile device 100 includes a virtual keyboard application 110. The virtual keyboard application, or, simply, keyboard application 110, may include an input layer or component configured to receive input (e.g., user-provided input) and produce a text string within a text input buffer 115 of the virtual keyboard application 110.

The virtual keyboard application 110 may interact with various applications supported by the mobile device 100, such as one or more messaging applications 140 (e.g., text messaging applications, email applications, chat applications, instant messaging applications, social network service applications, and so on), that facilitate the exchange of text-based communications between users, such as senders of messages and recipients of messages.

The keyboard (and associated keyboard application) is a useful place to add functionality. Typically, the keyboard is a layer of software that is often or always accessible when using a computing or mobile device and its various applications. Therefore, adding other functionality within or associated with a keyboard, such as a virtual keyboard would provide many benefits, such as easy or simple navigation between applications on a device, enhanced user interface capabilities, and other benefits. For example, the keyboard may act as an information exchange medium, enabling users to access data residing on their device or in locations to which their device communicates, exchange that information with applications or other programs running on the device, and parse the information, in order to provide secure communications for the various applications (e.g., messaging application 140) running on the mobile device 100.

The virtual keyboard application 110 may also include components/functionality of typical keyboard applications, such as components that may provide a text input functionality, a key tap functionality, a swipe, gesture, and/or contact movement functionality, or any other functionality that facilitates the reception of text-based input from a user. The components may cause the mobile device 100 to display a keyboard via a touch-screen, and receive input via a displayed keyboard presented via the touch-screen. The keyboard may be a virtual keyboard, such as any keyboard that is implemented on a touch-sensitive surface, a keyboard presented on a touch-sensitive display, a keyboard imprinted on a touch-sensitive surface, and so on. Example keyboards include a keyboard displayed on a monitor, a keyboard displayed on a touch-screen, a keyboard optically projected onto a flat or curved surface, and so on. In some cases, the keyboard may be “virtually” touched, such as a screen or projection that is controlled with some sort of pointer device or gesture recognizer.

In some embodiments, the virtual keyboard application 110 may perform recognition and/or disambiguation techniques to entered text when a user is inputting text, in order to assist users with entering text via small or complex displayed keys or keyboards.

In some embodiments, the virtual keyboard application 110 includes a keyboard obfuscation system 120 that is configured to generate coded messages, decode received coded messages, cause transient displays of otherwise coded messages, and so on. The keyboard obfuscation system 120 may access or otherwise receive text from the text input buffer 115, such as readable text entered by a user of the mobile device 100 while utilizing the messaging application 140 to enter and send a text or instant message to another user, and/or such as unreadable text received via the messaging application 140 and entered into the text input buffer 115 when the user receives a text or instant message at the mobile device 100.

The keyboard obfuscation system 120, therefore, may be configured to provide various levels of coding to messages for many different applications resident on the device 100, because the system 120 enables the virtual keyboard application 110 to act as a security intermediary by obfuscating text input by users before the text is provided to the applications.

In some embodiments, the keyboard obfuscation system 120 may utilize various language models 130 stored by or accessible to the virtual keyboard application when generated obfuscated or otherwise coded messages. These models include various human language (character) models (e.g., western alphabet languages, character-based languages, and so on), graphic-based models (e.g., emojis), and other constrained sets of characters or displayable objects or images.

Although shown in FIG. 1 as being integrated with the virtual keyboard application 110, the keyboard obfuscation system 120 may be implemented as part of the messaging application 140, as a stand-alone application within the operating system of the mobile device 100, and do on.

FIG. 1 and the discussion herein provide a brief, general description of a suitable computing environment in which the systems and methods can be supported and implemented. Although not required, aspects of the keyboard obfuscation system 120 are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

In some embodiments, the mobile device 100 includes network communication components that enable the mobile device 100 to communicate with remote servers or other portable electronic devices by transmitting and receiving wireless signals using a licensed, semi-licensed, or unlicensed spectrum over communications network, such as network. In some cases, the communication network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The communications network may also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

Those skilled in the art will appreciate that various other components may be included in the mobile device 100 to enable network communication. For example, the mobile device 100 may be configured to communicate over a GSM or newer mobile telecommunications network. As a result, the mobile device 100 may include a Subscriber Identity Module (SIM) card that stores an International Mobile Subscriber Identity (IMSI) number that is used to identify the mobile device 100 on the GSM mobile or other communications networks, for example, those employing 3G and/or 4G wireless protocols. If the mobile device 100 is configured to communicate over another communications network, the mobile device 100 may include other components that enable it to be identified on the other communications networks.

In some embodiments, the mobile device 100 may include components that enable them to connect to a communications network using Generic Access Network (GAN), Unlicensed Mobile Access (UMA), or LTE-U standards and protocols. For example, the mobile device 100 may include components that support Internet Protocol (IP)-based communication over a Wireless Local Area Network (WLAN) and components that enable communication with the telecommunications network over the IP-based WLAN. Further, while not shown, the mobile device 100 may include capabilities for permitting communications with satellites. The mobile device 100 may include one or more mobile applications that transfer data or check-in with remote servers and other networked components and devices.

Further details regarding the operation and implementation of the keyboard obfuscation system 120 will now be described.

Examples of Providing Secure Communications via a Keyboard Application

As described herein, providing the message obfuscation system 120 within the virtual keyboard application 110 enables end-to-end secure text-based messaging between various different devices, mobile applications, operating systems, and so on.

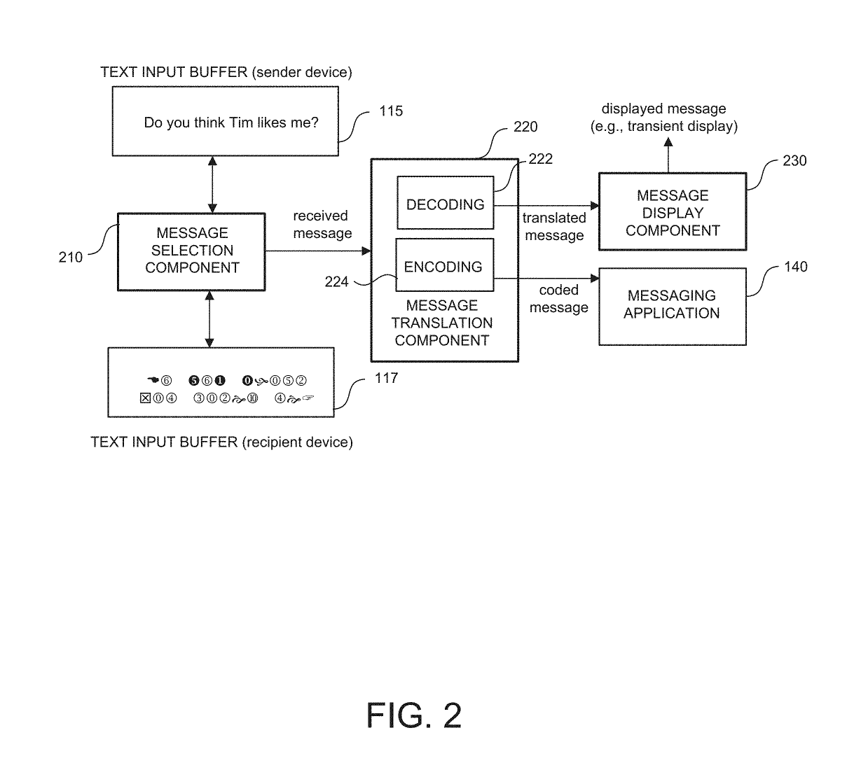

FIG. 2 is a block diagram illustrating components of the keyboard obfuscation system 120. The keyboard obfuscation system 120 may include functional modules that are implemented with a combination of software (e.g., executable instructions, or computer code) and hardware (e.g., at least a memory and processor). Accordingly, as used herein, in some examples, a module is a processor-implemented module and represents a computing device having a processor that is at least temporarily configured and/or programmed by executable instructions stored in memory to perform one or more of the particular functions that are described herein. For example, the mobile obfuscation system 120 may include a message selection component 210, a message translation component 220 (which includes a decoding component 222 and an encoding component 224), and a message display component 230.

In some embodiments, the message selection component 210 is configured and/or programmed to access or select text contained in the text buffer 115 of the virtual keyboard application 110. For example, a user may select some or all of a message created within the messaging application 140 and/or received by the messaging application 140, via one or more buttons or user interface elements provided by a virtual keyboard that interacts with the messaging application 140. In response to the selection, the message selection component 210 accesses the selected text in the text input buffer 115. As depicted, the message contained by the input buffer 115 may be in readable form (e.g., “Do you think Tim likes me?”) or unreadable form (e.g., “ [symbol] \textcircled{6} \textcircled{5} \textcircled{6} \textcircled{1} \textcircled{0} [symbol] \textcircled{0} \textcircled{5} \textcircled{2} [symbol] \textcircled{0} \textcircled{4} \textcircled{3} \textcircled{0} \textcircled{2} [symbol] \textcircled{10} \textcircled{4} [symbol] ”).

In some embodiments, the message translation component 220 is configured and/or programmed to translate the selected message. In some cases, when the message is in a readable form or version (e.g., the message is created and entered by the user), the message translation component 220, via an associated message encoding component 224, translates the message into an unreadable form or version (e.g., obfuscates the message). In such cases, the keyboard application 110, via the virtual keyboard, provides the unreadable, or coded, message to the messaging application 140, which may send the message to an intended recipient.

As an example, the message translation component 220 may receive a message to be translated, and perform a character substitution cypher process (e.g., where a=U, b=&, c=@, and so on), to obfuscate the message. In some cases, a sender or recipient name, phone number, device ID (e.g., IMSI or SIM) or other identifier associated with a sender or recipient may dictate or act as a seed or basis for the applied obfuscation algorithm, although other algorithms may be utilized.

The keyboard obfuscation system 120, via the message translation component 220, may apply various different levels of security or coding to messages.

For example, the system 120 may scramble an original, readable, message into an unreadable form using characters similar to those in the original message, may obfuscate the message into an unreadable form using characters from a different language or character set (e.g., emojis), and/or may encrypt the original message using various levels of encryption (e.g., public/private key encryption) to provide cryptographically secure messaging. Therefore, the system 120 may translate messages with varying levels of encoding, such as low-level encoding (e.g., scrambling), intermediate levels of encoding (e.g., obfuscation) high-level encoding (e.g., encryption), and so on.

In other cases, when the message is in an unreadable form or version (e.g., the message is received by the user), the message translation component 220, via an associated message decoding component 222), translates the message into a readable form or version (de-obfuscates the message).

In some embodiments, the message display component 230 is configured and/or programmed to display (e.g., temporarily) readable versions of coded messages translated by the translation component 220. For example, upon receiving a selection from a recipient of a coded message, the message display component 230 causes a transient display of a decoded (e.g., readable) version of the coded message, such as via the virtual keyboard.

Thus, in some embodiments, the message obfuscation system 120 of the virtual keyboard application facilitates the end-to-end coding and decoding of messages and other text-based communications between various different applications of mobile devices, such as messaging applications 140 and other applications that utilize a virtual keyboard for receiving text from users of the mobile devices.

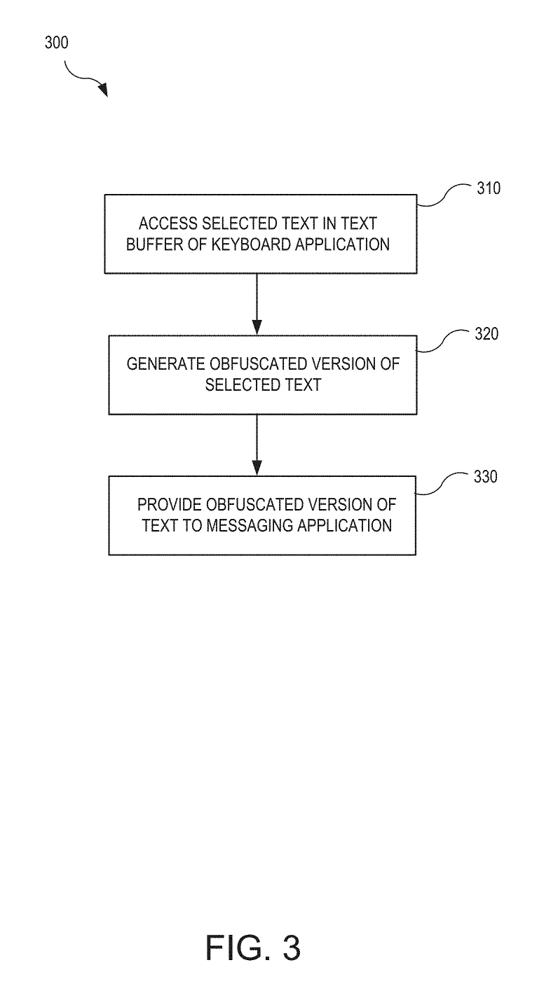

As described herein, the keyboard obfuscation system 120 may provide coded messages to various applications running on the mobile device 100. FIG. 3 is a flow diagram illustrating a method 300 for obfuscating a message via a virtual keyboard of a mobile device. The method 300 may be performed by the keyboard obfuscation system 120 and, accordingly, is described herein merely by way of reference thereto. It will be appreciated that the method 300 may be performed on any suitable hardware.

In operation 310, the keyboard obfuscation system 120 accesses a selection of text located in the text buffer 115 of the keyboard application 110. For example, the system 120 may access text entered by a user of the mobile device 100 via a virtual keyboard provided by the keyboard application 110 that interacts with the messaging application 140 of the mobile device 100.

In operation 320, the keyboard obfuscation system 120 generates an obfuscated version of the received selection of text. For example, the system 120 may receive a selection of text input by the user, and generate an unreadable version of the text in response to a user selection of a button or virtual element displayed by a virtual keyboard that received the input text.

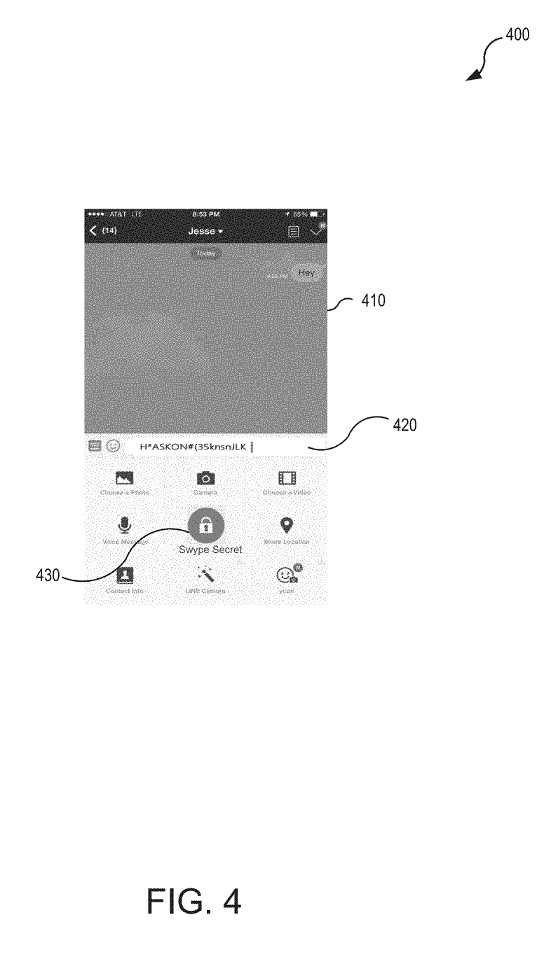

As an example, FIG. 4 is an example display 400 of a virtual keyboard interacting with a messaging application 410. The virtual keyboard, in response to receiving a user selection of a button 430 displayed within the virtual keyboard, generates and displays an obfuscated version 420 of a message input by the user.

As described herein, the keyboard obfuscation system 120 may apply various different levels of security or coding to messages. For example, the system 120 may scramble an original, readable, message into an unreadable form using characters similar to those in the original message, may obfuscate the message into an unreadable form using characters from a different language or character set (e.g., emojis), and/or encrypt the original message using various levels of encryption (e.g., public/private key encryption) to provide cryptographically secure messaging.

In addition, the keyboard obfuscation system 120, in some embodiments, generates coded versions of messages that include information associated with the transmission of messages between the parties. For example, an obfuscated message may include some or all of the following:

a portion that identifies the user of the mobile device as a sender of a message that includes the text in the text buffer;

a portion that identifies one or more intended recipients of the message that includes the text in the text buffer;

a portion that represents the text in the text buffer; and/or

a portion that identifies the type or format of coding utilized when the message was obfuscated;

a portion that includes a key or other information that identifies the transformation between the readable text and the unreadable message;

a portion that identifies the number of times a recipient client may be allowed to translate a received message; and/or

a portion that specifies a “lifetime” or permitted decryption window; such as a time period associated with a recipient device temporarily displaying the original message; and so on.

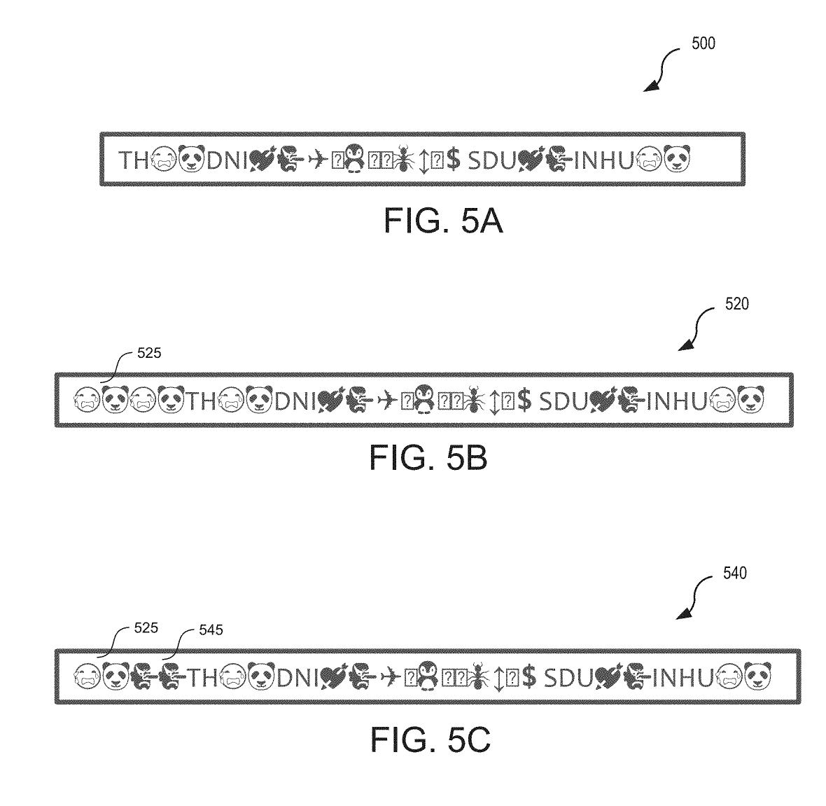

For example, FIGS. 5A-5C depict various different obfuscated versions of messages. In some cases, where the sender and recipient are known to one another, the keyboard obfuscation system 120 may generate an obfuscated message that simply includes the obfuscated contents of the message, as depicted in FIG. 5A.

In some cases, where an initial message is being sent from a sender to a recipient, the keyboard obfuscation system 120 may generate an obfuscated message that includes the obfuscated contents of the message and a portion 525 that identifies the sender of the message, as depicted in FIG. 5B.

Similarly, in some cases, where an initial message is being sent from a sender to multiple recipients, the keyboard obfuscation system 120 may generate an obfuscated message that includes the obfuscated contents of the message, the portion 525 that identifies the sender of the message, and a portion 545 that identifies one or more recipients of the message, as depicted in FIG. 5C. Of course, the keyboard obfuscation system 120 may include other types of information within coded messages.

Referring back to FIG. 3, the keyboard obfuscation system 120, in operation 330, provides the obfuscated version of the received selection of text to the messaging application 140 of the mobile device 100 for communication to a recipient device. For example, messaging application 140, which may be a text messaging application, instant message application, and so on, receives the obfuscated version of the text for transmission between parties. The keyboard application 110, after generating the obfuscated version of the text and providing the obfuscated version of the text to the messaging application 140, may then clear the text input buffer 115 without storing the readable version of the text. Thus, the readable version of text, originally input via the virtual keyboard, is not retained by either application.

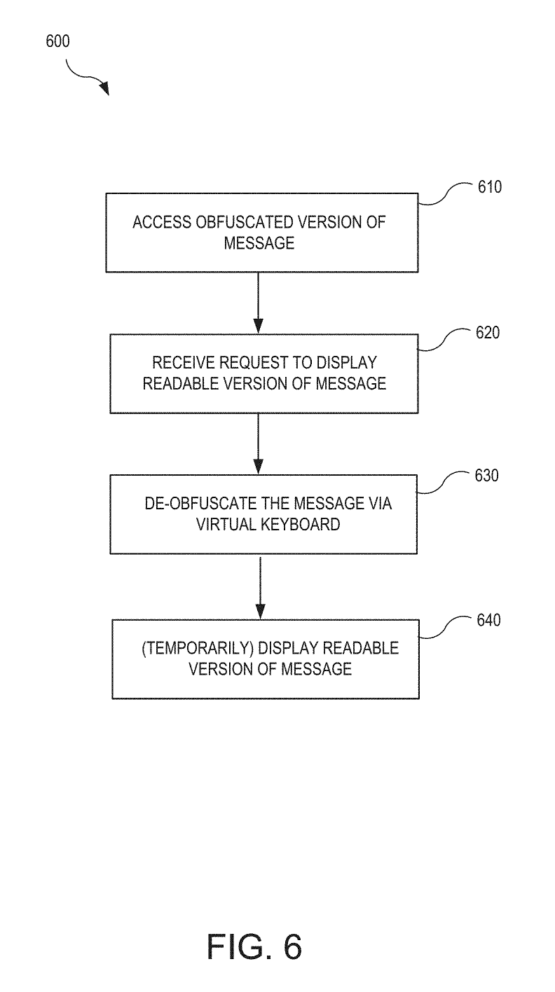

As described herein, the keyboard obfuscation system 120 may decode and/or display readable messages to recipients at their devices. FIG. 6 is a flow diagram illustrating a method 600 for displaying a message received by a messaging application of a mobile device. The method 600 may be performed by the keyboard obfuscation system 120 and, accordingly, is described herein merely by way of reference thereto. It will be appreciated that the method 600 may be performed on any suitable hardware.

In operation 610, the keyboard obfuscation system 120 accesses an obfuscated version of a text message. For example, the system 120 may access a message received and presented to a user within the messaging application 140 of the mobile device 100.

In operation 620, the keyboard obfuscation system 120 receives, via a virtual keyboard provided by the keyboard application 110, a request to display a de-obfuscated version of the text message. For example, the system 120 may receive input from the user via the virtual keyboard to “unlock” or “show” the message in readable form (e.g., via a button or display element of the virtual keyboard, gesture or other user action, and so on).

In operation 630, the keyboard obfuscation system 120 de-obfuscates the obfuscated version of the text message in response to the request. For example, the system 120 may identify the version or type of obfuscation associated with the obfuscated version of the text message, and de-obfuscate the obfuscated version via an associated key or other transformation information, such as information stored at or within the keyboard application 110.

In some cases the keyboard obfuscation system 120 employs various different security environments for a single keyboard application 110 or a group of similar keyboard applications. As a first example, all keyboard applications 110 may share a common key or transformation information, in order to apply the same or similar coding/decoding of messages.

As a second example, all keyboard applications 110 within a common device or operating system may share a common key or transformation information, in order to apply the same or similar coding/decoding of messages. As a third example, a keyboard application may apply a certain coding format or level of security that is based on the sender and/or recipient of a message. Of course, other factors may be considered when determining the level, format, type, and/or language to apply to message when coding message via the keyboard application 110.

In operation 640, the keyboard obfuscation system 120 displays a readable version of the text message to the user of the mobile device 100 based on the de-obfuscation of the text message. For example, the virtual keyboard may temporarily displaying the readable version of the text message to the user for a pre-determined period of time, such as by presenting a transient display of the readable version of the text message within a display environment of the virtual keyboard.

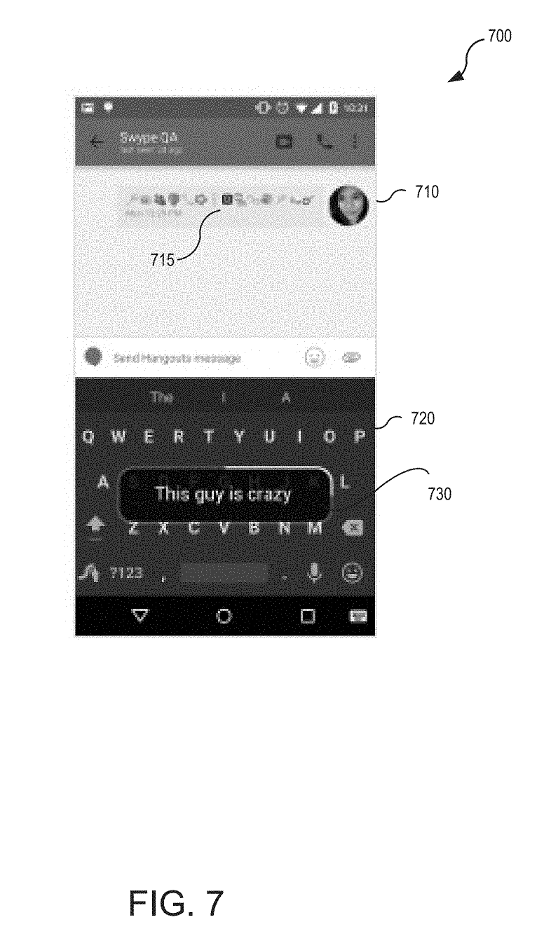

FIG. 7 is a display diagram illustrating a display 700 of a readable version of an obfuscated message generated by the keyboard obfuscation system via a virtual keyboard. The display 700 includes an obfuscated message 715 received by another user 710 and displayed via a messaging application. Upon receiving input from the recipient via a virtual keyboard 720 to present a readable version of the obfuscated message 715, the virtual keyboard, following the method 600 of FIG. 6, de-obfuscates the message 715, and presents a readable version 730 of the message via the virtual keyboard 720 (e.g., via a popup message generated by the virtual keyboard 720). As depicted, the readable version 730 is presented for a short, temporary period, of time (e.g., pre-determined by the keyboard application 110), and may include various indicia representative of a remaining display period.

Thus, in some embodiments, the systems and methods may facilitate secure (e.g., superficially or cryptographically) end-to-end message communications between users of mobile devices by providing an obfuscation mechanism within a virtual keyboard that interacts with various messaging applications of the mobile devices.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A method performed by a keyboard application of a mobile device, the method comprising:
accessing a selection of text located in a text buffer of the keyboard application, wherein the text was entered by a user of the mobile device via a virtual keyboard provided by the keyboard application and launched within a messaging application of the mobile device;
generating an obfuscated version of the received selection of text; and
providing the obfuscated version of the received selection of text to the messaging application of the mobile device for communication to a recipient.

2. The method of claim 1, wherein generating an obfuscated version of the received selection of text includes generating a coded version of the text in the text buffer that includes:
a first portion that identifies the user of the mobile device as a sender of a message that includes the text in the text buffer;
a second portion that identifies one or more intended recipients of the message that includes the text in the text buffer;
a third portion that represents the text in the text buffer.

3. The method of claim 1, wherein generating an obfuscated version of the received selection of text includes generating a coded version of the text in the text buffer that includes:
a first portion that identifies the user of the mobile device as a sender of a message that includes the text in the text buffer; and
a second portion that represents the text in the text buffer.

4. The method of claim 1, wherein generating an obfuscated version of the received selection of text includes generating a coded version of the text in the text buffer that includes:
a first portion that identifies one or more intended recipients of a message that includes the text in the text buffer;
a second portion that represents the text in the text buffer.

5. The method of claim 1, wherein generating an obfuscated version of the received selection of text includes replacing the received selection of text in the text buffer with an unreadable version of the text.

6. The method of claim 1, wherein generating an obfuscated version of the received selection of text includes generating a cryptographically secure version of the text.

7. The method of claim 1, wherein generating an obfuscated version of the received selection of text includes generating a translated version of the received selection of text using one or more language models accessible by the keyboard application.

8. The method of claim 1, wherein generating an obfuscated version of the received selection of text includes generating a graphical version of the received selection of text using one or more graphic character models accessible by the keyboard application.

9. The method of claim 1, wherein generating an obfuscated version of the received selection of text includes replacing the received selection of text in the text buffer with an unreadable version of the text that is specific to an intended recipient of a message that includes the text in the text buffer.

10. A non-transitory computer-readable storage medium whose contents, when executed by a keyboard application of a mobile device, cause the keyboard application to perform operations for displaying text to a user of the mobile device, the operations comprising:
accessing an obfuscated version of a text message presented by a messaging application of the mobile device;
receiving, via a virtual keyboard provided by the keyboard application, a request to display a de-obfuscated version of the text message;
de-obfuscating, using the keyboard application, the obfuscated version of the text message in response to the request; and
displaying, via the virtual keyboard, a readable version of the text message to the user of the mobile device based on the de-obfuscation of the text message.

11. The computer-readable storage medium of claim 10, wherein displaying a readable version of the text message to the user of the mobile device based on the de-obfuscation of the text message includes temporarily displaying the readable version of the text message to the user for a pre-determined period of time.

12. The computer-readable storage medium of claim 10, wherein displaying a readable version of the text message to the user of the mobile device based on the de-obfuscation of the text message includes presenting a transient display of the readable version of the text message.

13. The computer-readable storage medium of claim 10, wherein de-obfuscating the obfuscated version of the text message in response to the request includes de-obfuscating the obfuscated version of the text message using a de-obfuscation key stored within the keyboard application.

14. The computer-readable storage medium of claim 10, wherein displaying a readable version of the text message to the user of the mobile device based on the de-obfuscation of the text message includes displaying the readable version of the text message without storing the readable version of the text message at the mobile device.

15. The computer-readable storage medium of claim 10, wherein the obfuscated version of the text message is an unreadable version of the text message.

16. The computer-readable storage medium of claim 10, wherein the obfuscated version of the text message is a cryptographically secure version of the text message.

17. The computer-readable storage medium of claim 10, wherein the obfuscated version of the text message includes emoji characters representative of content of the text message.

18. The computer-readable storage medium of claim 10, wherein the obfuscated version of the text message is a version of the text message that includes encoding specific to the user of the mobile device.

19. A system of a keyboard application that is provided by a mobile device, the system comprising:
a message selection component that selects contents of a coded message received by a messaging application of the mobile device;
a message decoding component that decodes, within the keyboard application, the selected coded contents of the message received by the messaging application of the mobile device; and
a message display component that displays the decoded selected contents of the message via a user interface of the mobile device.

20. The system of claim 19, wherein the message display component temporarily displays the decoded selected contents of the message via the user interface of the mobile device.
